(19) United States
(12) Patent Application Publication
(10) Pub. No.: US 2007/0052637 A1
(43) Pub. Date: Mar. 8, 2007

(54) Color display panel

(76) Inventors: Andrea Giraldo, Eindhoven (NL); Mark Thomas Johnson, Eindhoven (NL); Klemens Brunner, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/575,579

(22) PCT Filed: Oct. 7, 2004
(86) PCT No.: PCT/IB04/52016

§ 371 Date: Apr. 11, 2006

(30) Foreign Application Priority Data
Oct. 16, 2003 (EP) 03103829.2

(51) Int. Cl. G09G 3/32

(52) U.S. Cl. 345/83

(57) ABSTRACT

A color display panel comprises at least one pixel. The pixel comprises a sub-pixel circuit of a type comprising a light-emitting cell (13) for emitting light with a first spectral distribution when a voltage in a first operating range is applied, and for emitting light with a different spectral distribution when a voltage in a second operating range is applied. The color display panel further comprises at least one data line (8) for passing a signal controlling the emission of light by the light-emitting cell to the first sub-pixel circuit. The sub-pixel circuit further comprises at least two active components (9, 10) for applying respective voltages to the cell (13) in dependence on respective reference voltages under control of the signal.

The invention relates to a color display panel, comprising at least one pixel having a sub-pixel circuit of a type comprising a light-emitting cell for emitting light with a first spectral distribution when a voltage in a first operating range is applied, and for emitting light with a different spectral distribution when a voltage in a second operating range is applied, the color display panel further comprising a data line for passing a signal controlling the emission of light by the light-emitting cell to the sub-pixel circuit

An example of such a color display panel is known from WO 98/59382. The known panel comprises a plurality of rows of individual pixels. In a preferred embodiment, the array of pixels is an active array. The color of individual pixels may be controlled by adjusting the voltage of the display. Each pixel can be set to a particular color as well as a selected brightness. For generating various gray levels for each color, pulse width modulation is applied. A color display may be obtained by running the display in a color sequential type mode. One way of doing this is to sequentially activate the red data, the green data, and the blue data one row at a time. Alternatively, full frames, each frame dedicated to one of the colorcolors may be generated sequentially. The full frame approach permits the display to be run at a maximum brightness when an active matrix transistor array is used. This permits DC-like operation of the display where illuminated pixels stay on until the data is changed and a momentary voltage pulse is applied.

A problem of the known device is that it is difficult to accurately control both the color and the intensity of light emitted by each pixel. This is due to the fact that a frame time has to be divided into many sub-frames, or sub-fields, in order to program each color component sequentially in combination with pulse width modulation to control the intensity of each emitted color component. For example, to have three colors and 256 different intensity levels, the frame time for the sub-pixel circuit must be divided into three times 256 sub-frame periods. This implies driving circuitry able to operate at very high and stable frequencies, making display devices incorporating the panel expensive, or it leads to inaccurate intensity and/or color setting.

It is an object of the present invention to provide a color display panel of the type defined above, which affords improved control over both the intensity and color of light emitted by the sub-pixels. The invention is defined by the independent claims. The dependent claims define advantageous embodiments.

This object is realized in that the sub-pixel circuit further comprises at least two active components controlled by the signal for applying respective voltages to the cell in dependence on respective reference voltages.

Each of the reference voltages may be stable power-supply voltages coupled to the sub-pixel circuit via respective power-lines. If gray levels are created in a digital way, for example, by using pulse width modulation, then the active components may be operated as switches which pass the reference voltages to the cell.

So, the respective voltages applied to the cell are, substantially equal to the respective reference voltages (apart from a negligible voltage drop across the active components). In case of only one active component would have been used, this active component would have to be operated as an analog device providing different voltages. As a result the provided voltages would depend on the parameters of the active component and would be less stable, so less accurate.

If gray levels are created in an analog way, for example, by driving the cell with a variable analog voltage within the first or the second operating range, then the active components may be operated as analog devices. Each of the analog devices receives its corresponding voltage, which, for example, is having a value near an extreme end of one of the operating ranges. So, a voltage drop across each of the active components various between about zero Volt and the maximum voltage difference within the concerned operating range. As a result, the voltage across each of the active components remains relatively low, so the influence of the parameters of the active components is relatively small, so the circuit with at least two active components is more accurate.

In a preferred embodiment, the color display panel comprises a further data line, at least one of the active components in the sub-pixel circuit being independently controllable by a signal supplied through an associated one of the data lines.

Thus, it is possible to take variations in characteristics of the active components into account, and adapt the signal controlling that active component in accordance with those characteristics.

A preferred embodiment comprises a storage element for maintaining a signal level controlling one of the active components at a level determined by a level of the signal supplied through the data line prior to interruption of supply of that signal to the sub-pixel circuit.

This allows the use of fewer data lines in a matrix display panel, for example, by combining the data lines of a plurality of sub-pixel circuits in a column. The use of fewer data lines to set each sub-pixel circuit to the required color and intensity level is enabled by supplying a control signal of short duration to each sub-pixel circuit in turn through one or more shared data lines.

In one embodiment, the active components are comprised in a bi-stable circuit, switchable between two states under control of the signal.

This embodiment has the advantage of allowing sequential driving of sub-pixel circuits in a matrix display panel, without necessarily requiring complicated storage arrangements for maintaining a sub-pixel circuit at a particular intensity and emission spectrum.

The light-emitting cell may be an organic light emitting diode.

According to another aspect of the invention, the method of driving a color matrix display panel comprising at least one pixel having a sub-pixel circuit of a type comprising a light-emitting cell for emitting light with a first spectral distribution when a voltage in a first operating range is applied, and for emitting light with a second spectral distribution when a voltage in a second operating range is applied, the second spectral distribution differing from the first spectral distribution, and a data line, the method comprises the steps of:

passing a signal controlling the emission of light by the light-emitting cell to the sub-pixel circuit via the data line; and

applying respective voltages to the cell in dependence on respective reference voltages via at least two active components controlled by the signal.

An embodiment of the invention comprises supplying at least one pre-conditioning pulse to the sub-pixel circuit for setting the respective voltages to a value within a sub-range at a substantially extreme end of an operating range furthest removed from the other operating range.

Thus, it is ensured that the sub-pixel circuit is operating in the intended operating range. More intense primary colors can thereby be displayed.

A preferred embodiment of the method of the invention comprises receiving consecutive sets of frame information, representing for each pixel intensity levels of at least two color components to be emitted by the pixel at a certain instant, setting intensity and color of light emitted by the sub-pixel circuit in accordance with information in one set of frame information within a frame period, wherein, within a frame period, in at least one sub-pixel circuit, a voltage difference in the first operating range and subsequently the second operating range is applied to the light-emitting cell.

Thus, a mix of colors are displayed, i.e. a color is perceived having a color in between those of the light-emitting cell when operated in the first and second operating ranges. This is so either because the colors follow each other so fast that the result is perceived as a blend of colors, or because of the kinetics of the light-emitting cell.

According to another aspect of the invention, there is provided a display system, comprising a color matrix display panel comprising at least one pixel having a sub-pixel circuit of a type comprising a light-emitting cell for emitting light with a first spectral distribution when a voltage in a first operating range is applied, and for emitting light with a second spectral distribution when a voltage in a second operating range is applied, the second spectral distribution differing from the first spectral distribution, the system further comprising means for carrying out a method according to the invention. This display system allows fast and accurate setting of both color and intensity of the light emitted by each sub-pixel in the color matrix display panel.

According to another aspect of the invention, there is provided a program having means for enabling a programmable device to carry out a method according to the invention.

This program allows the programmable device to run it to drive a color matrix display panel in the manner of the invention. It thus enables the attainment of the advantageous effects of the invention.

The invention will now be explained in further detail with reference to the accompanying drawings, in which:

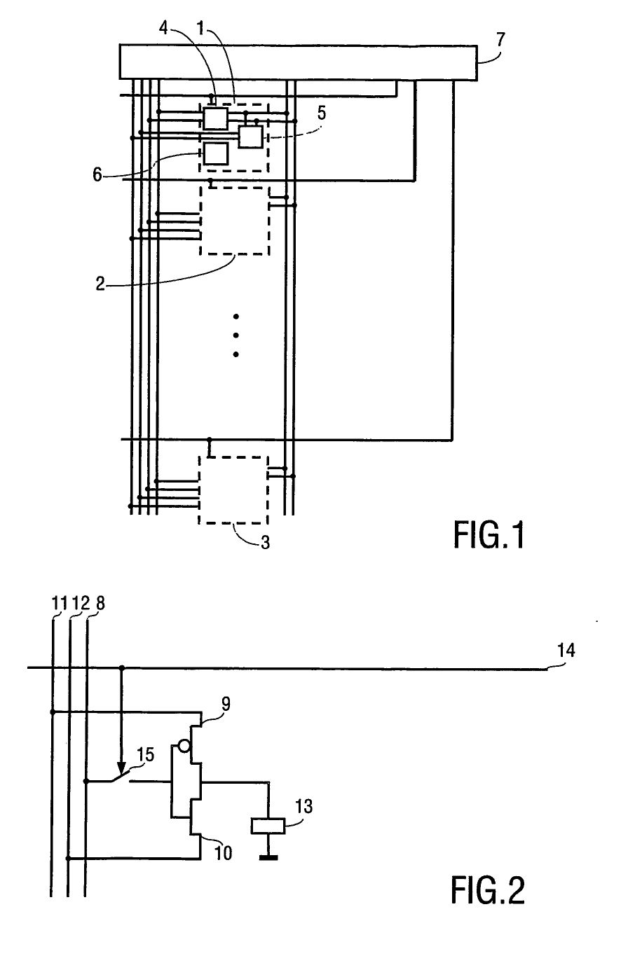

FIG. 1 shows schematically a column of pixels in a color matrix display;

FIG. 2 shows a first embodiment of a sub-pixel circuit and parts of the leads for conveying driving signals to it;

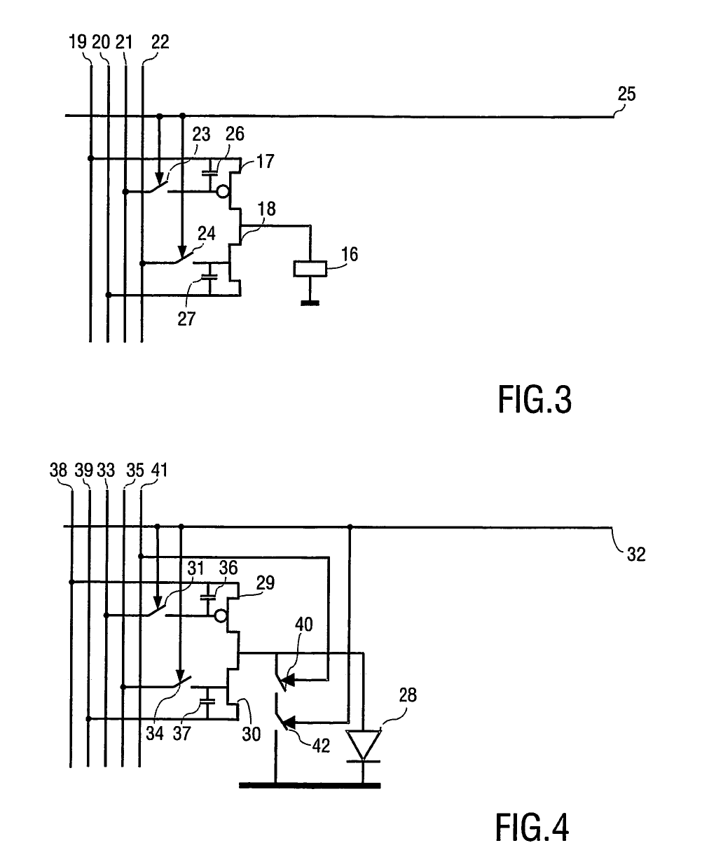

FIG. 3 shows a second embodiment of a sub-pixel circuit and parts of the leads for conveying driving signals to it;

FIG. 4 shows a third embodiment of a sub-pixel circuit and parts of the leads for conveying driving signals to it;

FIG. 5 shows the relationship between the driving signal and the output voltage across the electrodes of the light-emitting cell in the sub-pixel circuit of FIG. 2;

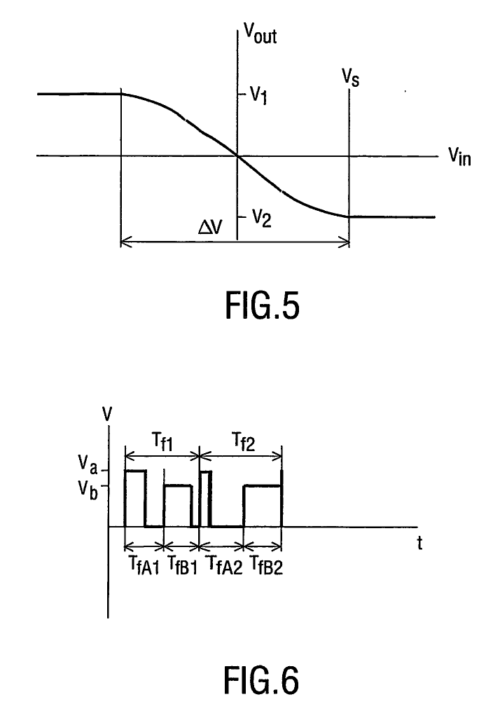

FIG. 6 shows an example of a waveform of a driving signal for driving the sub-pixel circuit of FIG. 4;

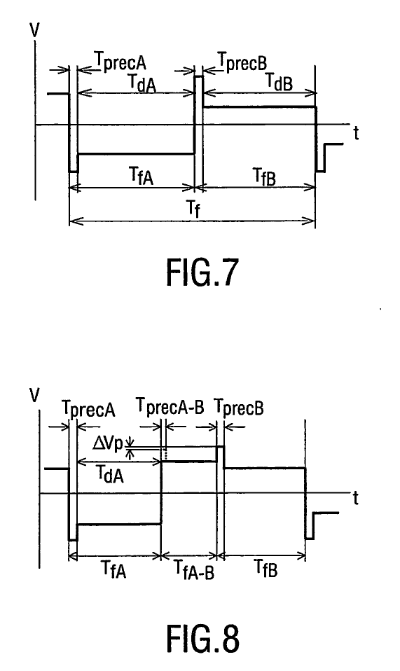

FIG. 7 shows an example of the waveform of a driving signal for driving the sub-pixel circuit of FIG. 2 or FIG. 3; and

FIG. 8 shows an example of the waveform of a driving signal for driving the sub-pixel circuit of FIG. 2 or FIG. 3 used to obtain color mixing.

FIG. 1 shows schematically a column of pixels 1-3 in a color matrix display panel. Each of the pixels 1-3 has a substantially similar layout, so that only a first pixel 1 is shown in more detail. The first pixel 1 comprises three sub-pixel circuits 406. A first sub-pixel circuit 4 and second sub-pixel circuit 5 are of a color-switchable type, being adapted to emit both red and green color components. Embodiments of sub-pixel circuits of this type will be described in more detail below. A third sub-pixel circuit 6 is adapted to emit only blue light.

Another embodiment of the invention is possible, in which the first and second sub-pixel circuit 4, 5 are of a type switchable to a third operating range, in which they emit light with a third spectral distribution, for example, having a peak at a wavelength corresponding to blue. In this embodiment, switching from red to green, green to blue and blue to red and back again would be possible. Also, in this embodiment all three sub-pixel circuits 4-6 may be of the same type. It goes without saying that other embodiments in which there are more than three sub-pixel circuits per pixel and/or each color is made up of more than three primary color components, are also within the scope of the invention.

A display controller 7 receives, consecutive sets of frame information, representing, for each of the pixels 1-3 intensity levels of three color components to be emitted by the pixel at a certain instant. Preferably, the three color components are red, green and blue, but a YUV signal could also be handled by the display controller 7. Where the information represents a very intense red component, both the first and second sub-pixel circuit 4,5 are operated in the same operating range. That is to say that both are set to emit light with a spectral distribution corresponding to a red color.

For the sake of a more concise and clearer presentation, each of FIGS. 24 shows one color-switchable sub-pixel circuit only.

One embodiment of the sub-pixel circuit according to the invention, shown in FIG. 2, comprises a bi-stable circuit, switchable between two states under control of a signal supplied through a data line 8. In this case, the bi-stable circuit comprises a CMOS inverter circuit, comprising a PMOS transistor 9 and an NMOS transistor 10. Other types of bi-stable circuit may be used and will readily occur to a person skilled in the art. For example, an NMOS or PMOS inverter circuit may be used. However, a CMOS inverter circuit is preferred, because it does not involve the use of resistors, and can therefore be made from polycrystalline silicon.

A first power line 11 and a second power line 12 are maintained at pre-determined voltage levels V₁ and V₂, respectively. The first and second power lines 11, 12 are connected to a sub-pixel circuit in each pixel of an array of pixels, for example, all or a sub-set of the pixels 1-3 in the column shown in FIG. 1. The transistors 9, 10 modulate the power supplied to a light-emitting cell 13 in the sub-pixel circuit. The light-emitting cell 13 is a device comprising two electrodes, an anode and a cathode, between which a voltage difference is applied. The light-emitting cells used in the invention are adapted to emit light with a first spectral distribution when a voltage difference in a first operating range is applied between the electrodes and to emit light with a second spectral distribution when a voltage difference in a second operating range, differing from the first operating range, is applied.

The invention can make use of any device that consists of at least two light emitting layers or, more generally, at least two light emitting phases. Phase means an entity showing different optical properties than a concomitantly present other entity. For example, the different phases may consist of different polymers or one phase may consist of a polymer and the other phase of a dye. Alternatively, one phase can be the bulk of a polymer, while the other phase is the interface of the polymer.

For example, if the recombination zone of the charge carriers is located in phase A, consisting of molecule A, then molecule A will emit and if the recombination zone is located in phase B, then molecule B will emit light. Note that the invention pertains only to active light-emitting cells, i.e. the source of illumination is located in the light-emitting cells, as opposed to passive, backlit devices.

The invention covers all members of at least two classes of devices. A first class comprises those devices that can be driven to emit light in two directions of current flow (forward and reverse bias), which will be called polarity switched devices here. A second class comprises devices with a diode characteristic, which can only be driven in one direction of current flow to give light (either in forward or reverse bias). Depending on the amount of biasing, the device will be in one or the other of at least two possible operating ranges.

Examples of the second class of devices are known, for example, from Berggren, M. et al., “Light-emitting diodes with variable colors from polymer blends”, Nature 372, p. 444-456, 1994. An example, of polarity switched cell can be found in Yang Yang and Qibing Pei, “Voltage controlled two color light-emitting electrochemical cells”, Applied Physics Letters 68 (19), p. 2708-2710, 1996, and in U.S.-B1-No. 6,235,414. An example of a device that belongs to both classes is known from Wang, Y. Z, et al., “Polarity and voltage controlled color-variable light-emitting devices based on conjugated polymers”, Applied Physics Letters 74 (18), p. 2593-2595, 1999.

This description will focus on the use of a sub-pixel circuit comprising a two color light-emitting cell described in more detail in co-pending Taiwanese patent application 092114763, by the same applicant. In this cell, there is, sandwiched between two electrodes, an electroluminescent device made of a soluble derivative of a semiconducting polymer, polyphenylenevinylene (PPV), molecularly doped with a homogeneously dispersed dinuclear ruthenium complex, which shows fully-reversible voltage dependent switching between green and red light emission. The device structure consists of a transparent ITO layer as a bottom electrode on a glass substrate, on which the active layer has been spun, and e.g. Au as a top electrode. The Ru-complex in the active layer fulfils the dual task of triplet emitter and electron transfer mediator. At forward bias (i.e. ITO-electrode at a higher potential than the Au-electrode), the excited state of the ruthenium compound is populated and the characteristic red emission of the complex is observed. Upon reversion of the bias, the lowest excited singlet state of the PPV polymer is populated, with subsequent emission of green light. Note that the device does not behave as a diode, but rather shows a nearly symmetric current vs. voltage behavior and emits red light at forward and green light at reverse bias. It is thus polarity switched. This single layer, color-switchable cell can be used with each of the embodiments of FIGS. 2-4.

Returning to FIG. 2, in order to switch between the two operating ranges, the first power line 11 will be at a positive voltage level with reference to a common ground at which one of the electrodes of the light-emitting cell 13 is maintained. The second power line 12 will be maintained at a negative voltage level. To set the voltage difference across the electrodes of the light-emitting cell 13, a row select signal is supplied through a row-select line 14, closing a row select switch 15. A signal controlling the emission of light is thus supplied through the data line 8 to the sub-pixel circuit, more precisely to the active components thereof, the PMOS transistor 9 and NMOS transistor 10. The former acts as a source of current to the light-emitting cell 13, whilst the latter acts as a sink of current from the light-emitting cell 13. Note that, as the CMOS inverter is bistable, the state is maintained as determined by the signal last provided through the data line 8 when the row select switch 15 is opened again. The voltage difference across the light-emitting cell 13 is determined by the voltage levels V₁ and V₂ at which the power lines 11, 12 are maintained, as well as the characteristics of the transistors 9, 10. Thus, the operating range is determined and thereby the color of emitted light. The intensity of emitted light is determined by the duration for which the sub-pixel circuit is in a particular state.

In the embodiment shown in FIG. 3, the intensity level can be set without switching. This embodiment also comprises a light-emitting cell 16 and two active components, again a PMOS transistor 17 and an NMOS transistor 18. The PMOS transistor 17 modulates power supplied through a first power line 19, whilst the NMOS transistor 18 modulates the power supplied through a second power line 20. The first power line 19 is maintained at a positive reference voltage V₁, whilst the second power line 20 is maintained at a negative voltage level V₂. Thus, the PMOS transistor 17 functions as a source of current, whilst the NMOS transistor 18 functions as a sink of current from the light-emitting cell 16.

The embodiment of FIG. 3 has the advantage that the PMOS transistor 17 and NMOS transistor 18 can be individually controlled by means of a signal supplied through a first data line 21 and a second data line 22, respectively. The signals supplied “program” the transistors 17 and 18 when row select switches 23, 24 connecting the gate of the PMOS transistor 17 to the first data line 21 and that of the NMOS transistor 18 to the second data line 22 respectively, are closed. The row select switches 23, 24 are controlled by a signal supplied through a row select line 25. When supply of the data signal through the first data line 21 to the gate of the PMOS transistor 17 is interrupted by the opening of the associated row select switch 23, the voltage level is maintained by means of a storage capacitor 26, controlling the PMOS transistor 17. Likewise, when the supply of the data signal through the second data line 22 to the gate of the NMOS transistor 18 is interrupted by the opening of the associated row select switch 24, the voltage level controlling the NMOS transistor 18 is maintained by the charge stored on a storage capacitor 27, controlling the NMOS transistor 18. Alternatively, the data signals can be supplied by the same data line if the two row select switches 23, 24 are controlled by two signals separately supplied through two row select lines.

Referring to FIG. 5, there is shown the voltage difference Vout across the light-emitting cell 13 of FIG. 2 as a function of the voltage level Vin (with reference to the common ground) supplied through the data line 8 (where the same signal is supplied simultaneously to the PMOS transistor 9 and NMOS transistor 10). It will be apparent that there is an “analogue window” ΔV, in which the light-emitting cell is current driven. That is to say, the amount of current through the light-emitting cell 13 is determined by the input voltage Vin, being the signal controlling the active components in the sub-pixel circuit Outside the analogue window, the device is voltage driven, one of the two transistors 9, 10 being fully open as a switch and the other fully closed.

It is noted that this set-up has the advantage that the size and shape of the analogue window can be adapted. By modifying the characteristics (I.e. channel width and length, threshold voltage, carrier mobility) of the transistors 9, 10 at manufacturing, the analogue window can be made more or less symmetrical. Similar adaptations can be achieved with a driving method, whereby the voltage levels V₁, V₂ of the power lines 11, 12 are varied.

When driving in the analogue window, for which the circuit of FIG. 3 is very suitable, tolerances on transistor characteristics may be taken into account. For example, if the PMOS transistor 17 and NMOS transistor 18 are not fully complementary, the use of separate data lines 21, 22 allows one to take this into account and to achieve a symmetric analogue window, for example. In other words, a so-called time-0 correction can be carried out Information characterizing each of the transistors 17, 18 is determined and stored at manufacturing. Driving circuits, such as the display controller 7 of FIG. 1, are arranged to loop up and take into account the stored information when setting the signal levels on the data lines for each individual sub-pixel circuit.

The circuit of FIG. 4 comprises a light-emitting cell 28 in the class of devices with a diode characteristic, which can only be driven in one direction of current flow to give light (either in forward or reverse bias). This class of devices can be driven also by the circuit of FIG. 3, by applying voltages V₁ and V₂ which are both positive with respect to the common ground level. In this embodiment, the sub-pixel circuit also comprises a PMOS transistor 29 and an NMOS transistor 30. A first row select switch 31 is controllable by a signal on a row select line 32 to selectively supply a signal through a first data line 33 to the gate of the PMOS transistor 29. A second row select switch 34 is controllable by the signal on the row select line 32 to selectively supply a signal through a second data line 35 to the gate of the NMOS transistor 30. When the supply of the control signal through the first data line 33 is interrupted, the last supplied voltage level is maintained by the charge on a first storage capacitor 36. Likewise, when the supply of the control signal through the second data line 35 is interrupted, the last supplied voltage level is maintained by the charge on a second storage capacitor 37. The voltage level at the source of the PMOS transistor 29 is set by the voltage level V₁ of a first power line 38 and the voltage level at the source of the NMOS transistor 30 is set by the voltage level V₂ maintained on a second power line 39. In this case, the two voltage levels V₁, V₂ are both positive with respect to the common ground of the light-emitting cell 28. Depending on the operating range, as determined by the signals supplied through the first and second data lines 33,35, the voltage is supplied to the light-emitting cell 28 reducing the voltage drop between the source and the drain of either the PMOS transistor 29 or the NMOS transistor 30, with the light-emitting cell 28 being either in the first or the second operating range. To quickly set the dark state of the light-emitting cell 28, a reset switch 40 is used, which receives a data signal via a further data line 41. A third row select switch 42, coupled in series with the reset switch 40, is controllable by the signal on the row select line 32. This third row select switch 42 allows setting the dark state only during the addressing time of that row. The reset switch 40 allows a fast transition to the dark state connecting the electrode of light-emitting cell 28 to the common ground, or alternatively to another common line via the third row select switch 42. In order to program the dark state, simultaneously to the reset data signal from the further data line 41, the two signals provided by the data lines 33,35 are such to set the PMOS transistor 29 and the NMOS transistor 30 in the off state.

In order to set the intensity level of the light-emitting cell 28 for each color emission, a pulse width modulation technique with sub-fields is preferred. The length of the sub-field determines the intensity level of the color emission. In this color sequential type mode, the intensity level of the two colorcolors determines the color point perceived by the human eye and its intensity. It is observed that sequential color mixing can be obtained not only by using the color sub-field but also using one or more frame periods. In general the color sub-field periods are short relative to the human visual system.

This method of driving is illustrated in FIG. 6. FIG. 6 shows the voltage V across the light-emitting cell 28 as function of time t during two consecutive frame periods T_{f1}-T_{f2}. Each frame period is divided into two sub-fields of substantially equal duration, T_{fA1}-T_{fA2} and T_{fB1}-T_{fB2}, each for one color emission. Within one color sub-field period, the light-emitting cell 28 is in one of the two operating ranges, for example, during a part of the sub-field T_{fA1} a voltage Vₐ within the first operating rage is supplied while during a part of the subject T_{fB1}, a voltage V_{b} within the second operating range is supplied. In each color sub-field more sub-fields are then used to determine the intensity level. For clarity's sake, these sub-fields are here called intensity sub-fields. The number of intensity sub-fields determines the number of intensity levels, usually called gray-scale resolution. In each color sub-field period, the row select switches 31,34,42 are closed by a signal on a row select line 32 and the data signals to make the light-emitting cell 28 bright of one of the two colors or dark are written into the first and the second storage capacitors 36, 37 for a number of times equal to the number of intensity sub-fields.

In the first sub-field T_{fA1} of the first frame period T_{f1}, the voltage V is predominantly supplied through the reduced voltage drop across the source and the drain of the PMOS transistor 29, as determined by signals supplied through the first and second data lines 33,35 and maintained by the first and second storage capacitors 36,37. In the second sub-field T_{fB1} of the first frame period T_{f1}, the voltage V₂ is predominantly supplied through the reduced voltage drop across the source and the drain of the NMOS transistor 30.

The intensity of emitted light is controlled by the reset switch 40. In the first color sub-field period T_{fA1}, of the first frame period T_{f1}, light is emitted during the first intensity sub-fields, which in this example corresponds to half the duration of the color sub-field period T_{fA1}. In the second color sub-field period T_{fB1}, of the first frame period T_{f1}, light is emitted for three quarters of the duration of the color sub-field period T_{fB1}. Likewise is shown that in the second frame period T_{f2}, the duration of the intensity sub-fields during the first color subfield T_{fA2} is shorter, while the duration of the intensity subfields during the second color subfield T_{fB2} are at its maximum value.

FIG. 7 illustrates a method of driving the sub-pixel circuit of FIG. 3. It shows the development of the voltage difference V as function of time t across the light-emitting cell 16 during one frame period T_{f}. It can be seen that, in this embodiment, the color sub-field periods T_{fA}, T_{fB} are both divided into a pre-conditioning period Tₚᵣₑₑ, shorter than the sub-pixel selection period, and a driving period T_{dA}. In a more general case only one color may need preconditioning. In this case the preconditioning period is only present in one of the color sub-fields. During the driving period T_{d}, the light-emitting cell 16 is driven in the analogue window of FIG. 5. Alternatively, a pulse width modulation technique with intensity sub-fields can also be used. During the sub-pixel selection, a pre-conditioning pulse is applied for the duration of the pre-conditioning period, which may be an infinitesimally small period. The pre-conditioning pulse has an amplitude within a sub-range at an extreme end of an operating range that is furthest removed from the other operating range. Preferably, it is at the extreme end of the analogue window shown in FIG. 5. The preconditioning pulse sets the light-emitting cell 16 in the optimal (chemical and/or physical) configuration to enable the cell 16 to emit light of the desired color after the pre-conditioning period. After pre-conditioning, i.e. during the driving period T_{d}, any value within the whole intensity region of the pre-set color can be selected. Where a sub-pixel circuit is to emit light of the same color for two consecutive frame periods (i.e. no emission of the other color), pre-conditioning pulse may be omitted.

So, color mixing may be achieved by, within a frame period, applying a voltage difference of first the first polarity and then, after a driving period, applying a voltage difference of opposite polarity. If the voltage of the opposite polarity follows the first polarity substantially immediately, or after a very short delay, then during a short intermediate period the light-emitting cell emits a mixture of the colors. This is achieved, making use of the color kinetics of the light-emitting cell. When removing the voltage of the first polarity, the emission of the corresponding first color does not stop immediately, but decreases gradually. As a result, during the intermediate period the cell still emits some of the first color corresponding to the first voltage as well as the second color corresponding to the opposite voltage.

FIG. 8 shows an improved method of driving to obtain color mixing. In this case, within one frame period in which an intermediate color is to be displayed, a first pre-conditioning pulse of a first polarity is applied at the start of a first color sub-field T_{fA} and a second pre-conditioning pulse of a different polarity is applied at the start of an intermediate color sub-field T_{fA-B}. To obtain better color mixing, the second pre-conditioning pulse preferably has a shorter duration T_{precA-B} than a duration T_{precA} of the first pre-conditioning pulse. In an extreme situation the duration T_{precA-B} can be equal to zero. Alternatively, or additionally, the pulse amplitude is kept lower by an amount ΔVp than the amplitude normally required to completely bias the light-emitting cell 16.

A third pre-conditioning pulse with duration T_{precB} is applied at the start of the next sub-field with duration T_{fB}. This third pre-conditioning pulse ends the state of color mixing, so that after this pulse only the second color is generated.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. Color display panel comprising:
at least one pixel (1-3) having a sub-pixel circuit (4,5) of a type comprising a light-emitting cell (13;16;28) for emitting light with a first spectral distribution when a voltage in a first operating range is applied, and for emitting light with a second spectral distribution when a voltage in a second operating range is applied, the second spectral distribution differing from the first spectral distribution; and
a data line (8;21,22;33,35,41) for passing a signal controlling the emission of light by the light-emitting cell (13; 16; 28) to the sub-pixel circuit (4,5), the sub-pixel circuit (4,5) further comprising at least two active components (9,10;17,18;29,30) controlled by the signal for applying respective voltages to the cell (13;16;28) in dependence on respective reference voltages.

2. Color display panel according to claim 1, comprising a further data line (21,22;33,35), at least one of the active components (17,18;29,30) in the sub-pixel circuit (4,5) being independently controllable by the signal supplied through an associated one of the data lines (21,22;33,35).

3. Color display panel according to claim 1, further comprising a storage element (26,27;36,37) for maintaining a signal level controlling one of the active components (17,18;29,30) at a level determined by a level of the signal supplied through the data line (8;21,22;33,35) prior to interruption of supply of that signal to the sub-pixel circuit (4,5).

4. Color display panel according to claim 1, wherein the active components (9,10) are comprised in a bi-stable circuit, switchable between two states under control of the signal.

5. Color display panel according to claim 1, wherein a first one of the at least two active components (9; 17) is arranged to function as a source of current to the light-emitting cell (13;16) and a further one of the at least two active components (10;18) is arranged to function as a sink of current from the light-emitting cell (13;16).

6. Color display panel according to claim 2, the sub-pixel circuit (4,5) further comprising a reset switch (40, 42) coupled in parallel with the light-emitting cell (28) for setting a dark state of the cell (28).

7. Color display panel according to claim 1, comprising at least two sub-pixel circuits (4,5) of the same type.

8. Color display panel according to claim 7, adapted to enable driving of the at least two sub-pixel circuits (4,5) in a same operating range.

9. Method of driving a color matrix display panel comprising at least one pixel (1-3) having a sub-pixel circuit (4,5) of a type comprising a light-emitting cell (13;16;28) for emitting light with a first spectral distribution when a voltage in a first operating range is applied, and for emitting light with a second spectral distribution when a voltage in a second operating range is applied, the second spectral distribution differing from the first spectral distribution, and a data line (8;21,22;33,35,41), the method comprising the steps of:
passing a signal controlling the emission of light by the light-emitting cell (13;16;28) to the sub-pixel circuit (4,5) via the data line (8;21;22;33,35,41); and
applying respective voltages to the cell (13;16;28) in dependence on respective reference voltages via at least two active components (9,10;17,18;29,30) controlled by the signal.

10. Method according to claim 9, comprising supplying the signal to the corresponding one of the active components (17,18;33,35) at a level in dependence on information characterizing the corresponding active component (17,18;29,30).

11. Method according to claim 9, comprising supplying at least one pre-conditioning pulse to the sub-pixel circuit (4,5) for setting the respective voltages to a value within a sub-range at a substantially extreme end of an operating range furthest removed from the other operating range.

12. Display system comprising a color matrix display panel comprising at least one pixel (1-3) having a sub-pixel circuit (4,5) of a type comprising a light-emitting cell (13;16;28) for emitting light with a first spectral distribution when a voltage in a first operating range is applied, and for emitting light with a second spectral distribution when a voltage in a second operating range is applied, the second spectral distribution differing from the first spectral distribution, the system comprising means for carrying out a method according to claim 9.

13. Program having means for enabling a programmable device to carry out a method according to claim 9.
